(19) United States
(12) Patent Application Publication
(10) Pub. No.: US 2012/0269705 A1
(43) Pub. Date: Oct. 25, 2012

(54) SYSTEM FOR SELECTIVE CATALYST REDUCTION

(75) Inventors: Anders E. Jensen, Allerod (DK); Anders Færch Weiss, Copenhagen N (DK); Andreas Aabroe Gamborg, Copenhagen S (DK); Steen Kähler, Tikob (DK); Snorre Krogh Biehe, Roskilde (DK)

(73) Assignee: DANSK TEKNOLOGI PRODUKTIONSAKTIESELSKAB, Allerød (DK)

(21) Appl. No.: 13/510,246

(22) PCT Filed: Nov. 19, 2010
(86) PCT No.: PCT/DK10/50313

§ 371 Date: Jun. 25, 2012

(30) Foreign Application Priority Data
Nov. 20, 2009 (DK) PA 2009 70217

(51) Int. Cl. B01D 53/94

(52) U.S. Cl. 423/212; 422/168

(57) ABSTRACT

The invention relates to a system and method for selective catalyst reduction (SCR), where the addition of reducing agent is administered by a control portion and injected into a gas by an injection portion upstream of a catalyst portion. In some embodiments of the invention the injection portion comprises a plurality of injection nozzles.

### FIELD OF THE INVENTION

The present invention relates to an exhaust gas treatment system, in particular to a system for selective catalyst reduction (SCR) including soundproofing. A primary focus of the invention is SCR for larger Diesel engines (e.g. with an effect being larger than 750 KW)

### BACKGROUND OF THE INVENTION

The emission of NOₓ SOₓ and particulate matter (PM) are of primary concern for users of larger diesel engines in order to meet future emission standards. Diesel vehicles and vessels have significant advantages over their gasoline counterparts including a more efficient engine, higher fuel economy, and lower emissions of HC, CO, and CO₂. For example, diesel vehicles potentially have a 40% higher fuel economy than current gasoline vehicles with 20% lower CO₂ emissions.

Control of NOₓ or SOₓ, onboard a diesel vehicle or vessel is not a trivial task due to the high oxygen content of the exhaust gas.

Such high oxygen fuel systems are typically referred to as lean burn systems. In such lean burn systems, NOₓ control is more difficult because of the high O₂ concentration in the exhaust, making conventional three-way catalysts ineffective. The available technologies for NOₓ reduction in lean environments include Selective Catalytic Reduction (SCR), in which NOₓ is continuously removed through active injection of a reducing agent over a catalyst and Lean NOₓ Traps (LNT), which are materials that adsorb NOₓ under lean conditions and must be periodically regenerated. Technologies utilizing an ammonia-based reducing agent, such as aqueous urea, have shown potential in achieving high NOₓ conversion with minimal fuel economy penalty. Selective Catalytic Reduction (SCR) with ammonia as the reducing agent has been used extensively for stationary source NOₓ control. The high selectivity of ammonia for reaction with NOₓ in high O₂ environments makes SCR attractive for use on diesel vehicles. Compared to ammonia, aqueous urea is much easier for use onboard a vehicle.

Selective Catalytic Reduction (SCR) Technology is found to be one of the most effective methods of meeting future emission standards. The basic technology is well know and used in truck and bus applications (e.g. engines <750 KW). But due to both space requirements, extra counter pressure from the catalyst giving a fuel economy penalty and problems with efficiency of the traditional SCR systems only a small number of installations have been made on larger diesel engine installations (typically engines >750 KW).

In addition, catalytic elements are in the known system a separate part of the exhaust system and it is typically placed upstream of a muffler that soundproofs the exhaust system. Thereby, space taken up by the exhaust system is increased when catalytic elements are arranged in the exhaust system. Furthermore, the inclusion of a SCR system in the exhaust system also requires space and the SCR system often require some mixing means inside the piping to assure mixing between the reducing agent and the exhaust gas. A still further issue to be considered is the amount of compressed air used to atomize (or similar droplet formation) of the liquid reducing agent when introduced into the exhaust gasses.

From a fuel consumption perspective, the muffler, the SCR system, mixing means and use of compressed air all represent energy consumtion by the engine and the consequence of the known systems is that introduction of muffler, SCR, mixing and use of compressed air results in higher fuel consumption and larger space taken up by the exhaust system.

An highly compact and improved system for selective catalyst reduction would be advantageous, and in particular a more efficient and/or reliable dosing and exploitation of the reducing agent would be advantageous.

### OBJECT OF THE INVENTION

An object of the present invention is to provide an improved way for dosing of a reducing agent in a system for selective catalyst reduction and at the same time have a very efficient mixing giving an efficient system. Another object of the invention, is to make a very compact SCR system that can work as and replace the traditional muffler without requiring extra space or giving extra counter pressure.

### SUMMARY OF THE INVENTION

Thus, the above described object and several other objects are intended to be obtained in a first aspect of the invention by providing a system for selective catalyst reduction, comprising:
an inlet of a gas to be catalytically reduced
a control portion to administer an amount of reducing agent to be mixed with the gas to be catalytically reduced,
a doser portion that measures out the amount of reducing agent administered by the control portion,
an injection portion that injects the reducing agent into the gas to be catalytically reduced upstream of,
a catalyst portion that reduces the gas to be catalytically reduced to a reduced gas,
an outlet of the reduced gas.

In the present context, the term “portion” has been used to designate features of the invention. The term portion is used in a manner being ordinary to a skilled person and preferably in the meaning an element, a section, a region or the like either being a mechanical or electrical entity or a part of such entity.

It is noted, that the injection portion typically injects the reducing agent in an airless manner by which the reducing agent, being a liquid, is injected as liquid and the atomization or droplet formation is performed without the assistance of atomization fluids such as compressed air. Typically, the atomization is performed by forming jets which impinges each other thereby forming droplets.

Furthermore, the invention is herein disclosed with focus on removal of NOₓ. However, it is noted that removal of other substances such as SOₓ may be provided by the present invention by using a suitable catalyst and agent.

An advantage of the invention is that the catalyst portion may be designed so as to act as a muffler.

In a preferred embodiment of the invention the injection portion comprise a plurality of injection nozzles.

Preferably, the injection nozzles is adapted to atomize the reducing agent without the need for compressed air to facilitate the atomization.

It may be advantageous, when injecting the reducing agent into the gas to be catalytically reduced, to have a series of injection nozzles to provide a homogeneous injection.

In another preferred embodiment of the invention injection of reducing agent by each of the plurality of injection nozzles is controlled individually by the control portion.

When injecting the reducing agent through a series of injection nozzles it might in some embodiments of the invention be advantageous to control injection by each nozzle separately.

In preferred embodiments of the invention the control of the injection by the plurality of injection nozzles is done in a way that evenly distributes the use of each nozzle. This will ensure that the wear of each nozzle is kept at a minimum.

In many practical embodiments, the exhaust system comprising a number of turns and bends in the piping which result in a velocity distribution of the exhaust gas in the pipes being skewed. In other cases, the engine by it self may introduce such skewed velocity profiles. Thus, differences in mass flow will be present across a cross section of e.g. pipe of the exhaust system. If this skewness is not matched by matching the amount of reducing injected locally in the flow, a strong mixing downstream of the injection will be required to provided a uniform distribution of the reducing agent in the exhaust gas. An important advantage of using a plurality of individual nozzles is that the introduction and thereby distribution of a reducing agent can be mathed a skewed velocity profile in the exhaust system.

Thus, the present invention suggests to match the amount of reducing agent to skewness in the flow in the exhaust gasses. This is in some embodiments provided by using a plurality of injection nozzles, that e.g. can be distributed at different locations on the exhaust system.

Accordingly, in preferred embodiments of the invention, the control of the injection by the plurality of injection nozzles is done in a way that maximizes the mixing between reducing agent and the gas to be catalytically reduced, preferably without the need for a static mixer and/or air treatment unit which both gives an extra counter pressure and thereby also a fuel economy penalty.

By the control of the injection of several nozzles, a better mixing between reducing agent and gas can be provided; this increases the efficiency of the SCR system.

In preferred embodiments of the invention, the catalyst portion is adapted to soundproof the exhaust from the engine connected to the selective catalyst reduction portion. The soundproofing may preferably be provided by catalyst elements being arranged in serie with a void in between.

Thus, when the gas flows through the catalyst portion it is being compressed and expanded several times whereby the catalyst portion acts like what is know as an “expansion chamber muffler”.

By adapting the catalyst portion to provide soundproofing, elimination of the need for a traditional muffler may be provided, and preferred embodiments of the invention may advantageously not comprise a separate soundproofing element.

In addition, when the catalyst portion also works as a muffler there is less counter pressure than the traditional installations where a muffler is needed. This, means that there is no fuel penalty in such SCR installations.

In preferred embodiments of the invention, the catalyst portion comprises blowing portions to remove soot buildup. Such blowing portions may advantageously be coinciding with the voids between the catalyst elements.

In preferred embodiments of the invention, a sensory device determines the level of content to be reduced in the gas to be catalytically reduced.

In preferred embodiments of the invention, the control portion uses the information from the sensory device to administer the amount of reducing agent to be injected into the gas to be catalytically reduced.

In preferred embodiments of the invention, a sensory device determines the level of content to be reduced before it exits the system for selective catalyst reduction.

In preferred embodiments of the invention, the information from the sensory device that determines the level of content to be reduced before it exits the system is fed back to the control portion.

In other preferred embodiments of the invention the amount of reducing agent to be injected into the gas to be catalytically reduced is derived from a “urea dosing mapping” such as the load of the engine combined with a dosing amount table stored in the control portion. This means that the sensory device that determines the level of content to be reduced can be omitted.

The “urea dosing map” can be obtained manually by changing the amount of reducing agent and checking the engine emission to find the optimum amount of reducing agent to be delivered (typically being all NOx removed and no exceess of Urea or ammonia exhaust from the exhaust system) for a given engine load. But it can also be obtained automatically using a temporary or permanently installed sensory device in the system.

In preferred embodiments of the invention, the information from a sensory device that determines the level of content to be reduced before it exits the system is fed back to the control portion. This information combined with the engine load is then used to obtain a “urea dosing map”.

In preferred embodiments of a system according to the present invention, the control portion comprising a urea dosing map storing corresponding values of reducing agent to be injected and engine load and the control portion is adapted to control the injection of reducing agent by the plurality of nozzles based on the urea dosing map.

Preferably, the doser portion is a digitally controlled positive displacement pump adapted to secure that the reducing agent is metered and dosed without any accumulating faults.

The invention further relates to a method for selective catalyst reduction of a gas to be catalytically reduced, the method comprising administering an amount of reducing agent to be mixed with the gas to be catalytically reduced and measure out this amount of reducing agent and injecting it into the gas to be catalytically reduced upstream of a catalyst portion that reduces the a gas to be catalytically reduced to a reduced gas.

Injection of the reducing agent by a plurality of nozzles into exhaust gasses, may according to the present invention preferably comprise controlling the injection by a control portion comprising, preferably storing in a memory, a urea dosing map storing corresponding values of reducing agent to be injected and engine load.

As it appears from the above, systems and methods according to the present invention may at least potentially by very compact and result in less fuel consumption. The effect of avoiding the conventional muffler reduces the space needed for the exhaust gas treatment system. Another important issue is that due to the e.g. the efficient distribution of reducing agent matching the mass flow of the exhaust gas and mixing, a higher NOx removal may be obtained. As a higher NOx removal can be obtained, the engine may be tuned or operated at a relatively higher level of fuel efficiency which higher level generally will produce a relatively higher NOx production.

The present invention has proven to be particular important when applied to larger Diesel engines, that is engines having an effect larger than 750 KW, such as larger than 1 MW. In addition, the invention is very well suited for marine Diesel engine and stationary Diesel engines used e.g. for electrical power production.

Any aspects or features of the present invention may each be combined with any of the other aspects or features. These and other aspects of the invention will be apparent from and elucidated with reference to the embodiments described hereinafter.

### BRIEF DESCRIPTION OF THE FIGURES

The system for selective catalyst reduction according to the invention will now be described in more detail with regard to the accompanying figures. The figures show ways of implementing the present invention and are not to be construed as being limiting to other possible embodiments falling within the scope of the attached claim set.

FIG. 1 is schematic representation of the system for selective catalyst reduction.

FIG. 2a is a cross-sectional (only the part 19 is a sectional view) view of an embodiment of the invention.

FIG. 2b is an embodiment of the tube portion with a plurality of injection nozzles.

FIG. 3a is a 3D view of an embodiment of the invention.

FIG. 3b is a sectional view of the embodiment of the invention shown in FIG. 3a.

FIG. 3c is detailed sectional views of the embodiment of the invention shown in FIG. 3b (the level of details shown in the figures vary for clarity reasons).

FIG. 3d is a detailed sectional views of top shown toghether with a cross section view of a catalyst portion of the embodiment of the invention shown in FIG. 3b (the level of details shown in the figures vary for clarity reasons).

FIG. 3e is sectional views of the embodiment of the invention shown in FIG. 3a installed in a vessel (with two engines) in the same space that was originally used for the standard mufflers (the level of details shown in the figures vary for clarity reasons).

FIG. 4a is a diagram of the system for selective catalyst reduction according to the invention.

FIGS. 4b and 4c are diagrams showing the system without the need for a permanently installed sensory device to determine the level of content to be reduced.

### DETAILED DESCRIPTION OF EMBODIMENTS

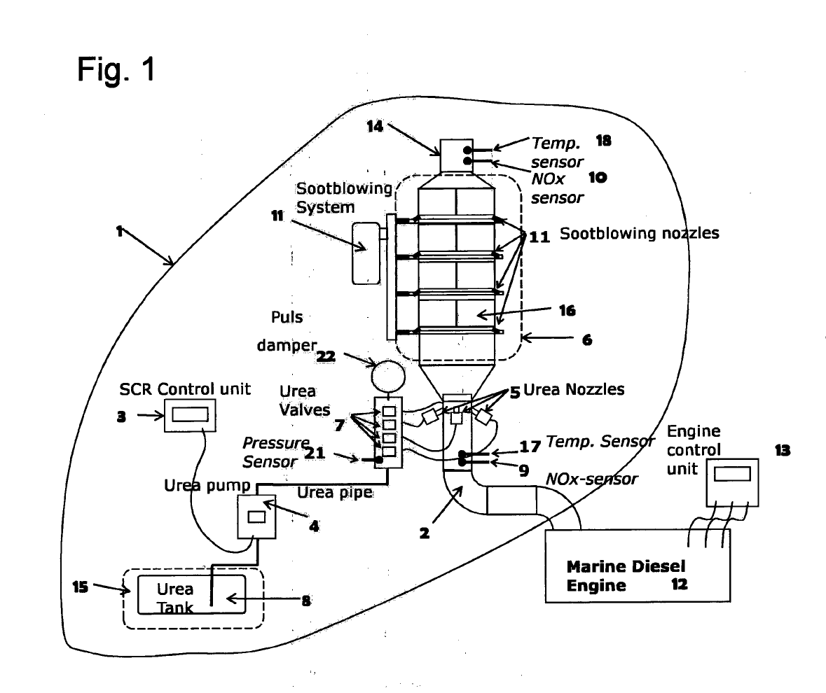

By way of overview, FIG. 1 illustrates a selective catalytic reduction system 1 in accordance with the present invention. Therein, an internal combustion engine 12, in this embodiment the internal combustion engine being a marine diesel engine, exhausts a gas 2 containing NOₓ and/or SOₓ into the selective catalyst reduction system 1 (for simplicity, reference is in the followed made mainly to NOₓ only). The piping connected to the engine represents an example of an inlet of gas to be catalytically reduced of the system. An electronic controller 3 sends a control signal to a reducing agent doser 4 (in FIG. 1a in the form of a Urea pump being in the form of a digitally controlled positive displacement pump), this doser 4 measures up the volume of reducing agent 15 requested by the controller 3 from a tank 8 and pumps it through a set of valves 7 to the injection nozzles 5, from where the reducing agent 15 is injected into the exhaust gas 2 to be catalytically reduced. When the reducing agent 15 is injected, the gas 2 enters the catalyst portion 6 with the catalyst elements 16 and the NOₓ is wholly or partially removed from the gas 2. The catalyst portion 6 comprises a soot blowing system 11 to avoid build-up of soot in the catalyst portion 6. The catalyst portion 16 works also as a muffler. The catalyst elements 16 is preferably embodied as a Honey Comp structure.

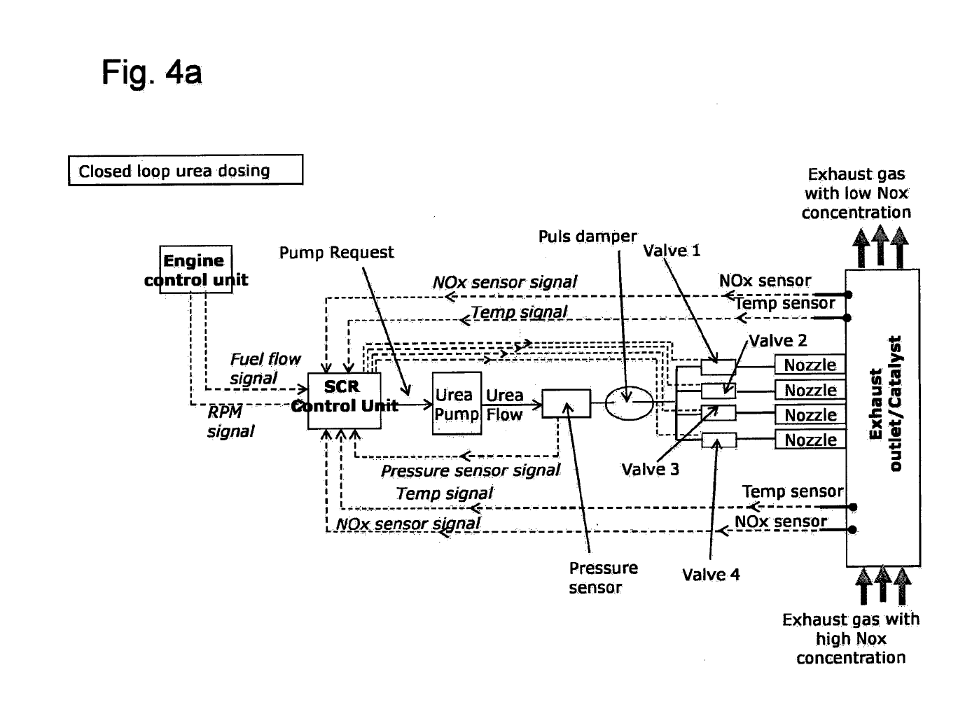

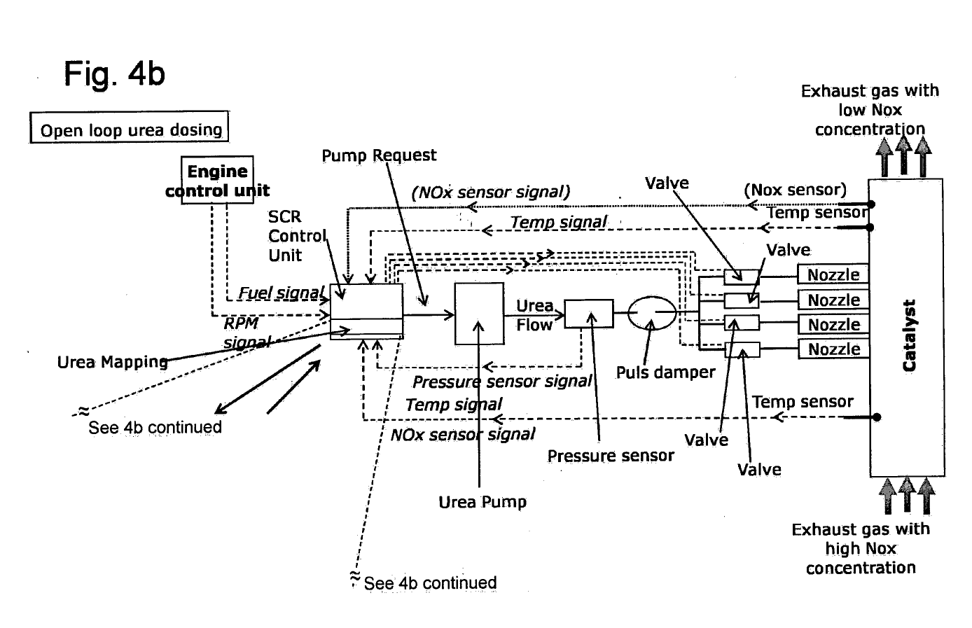

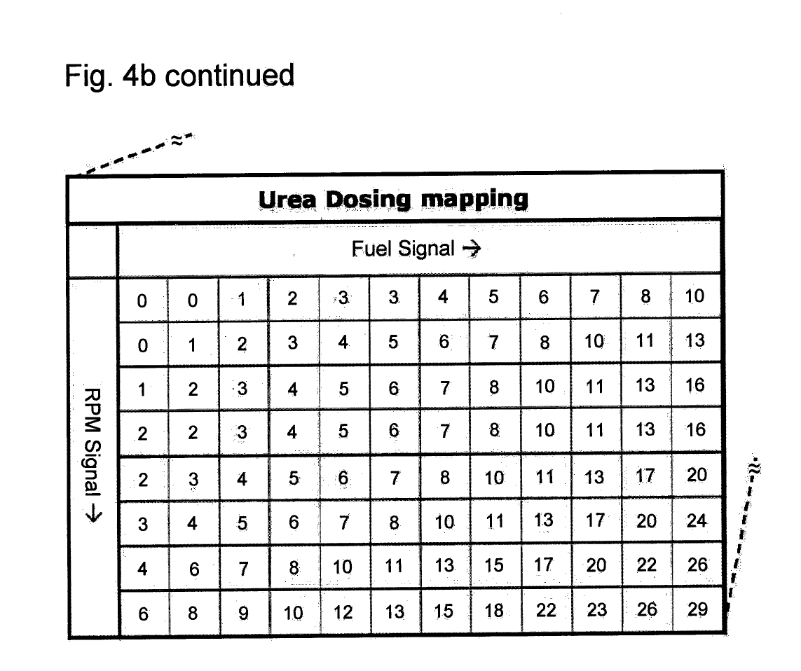

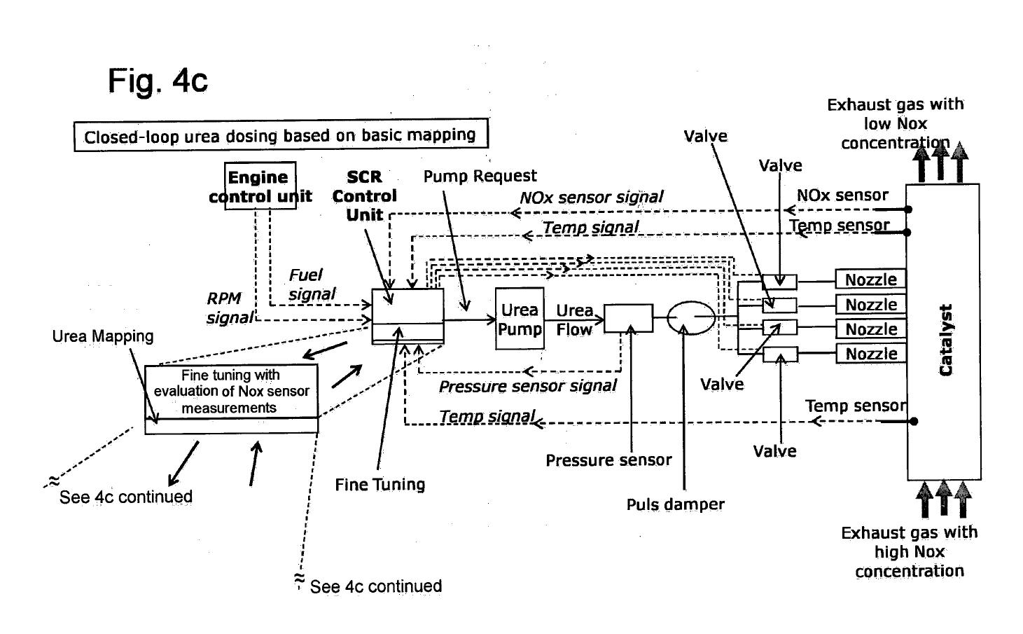

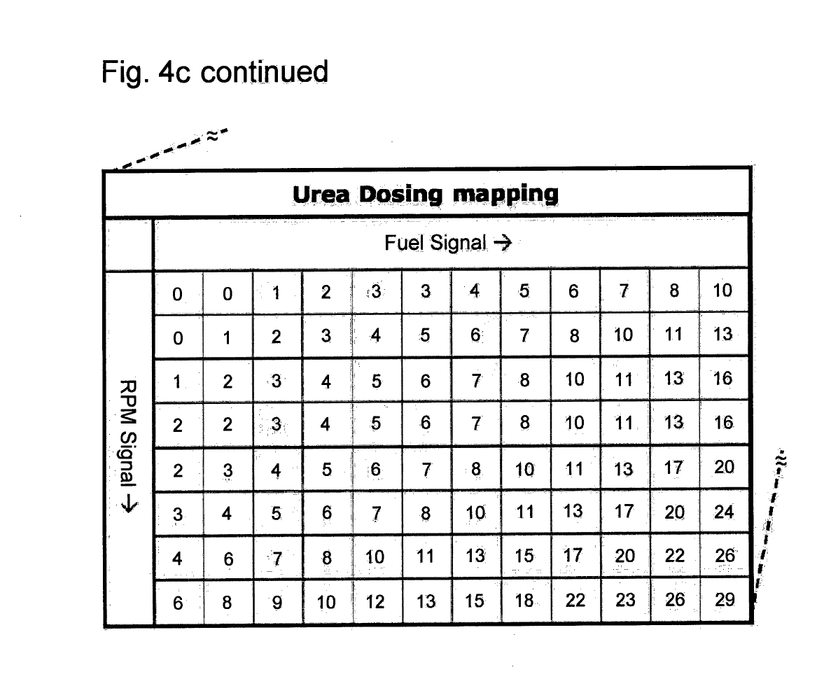

Reference is made to FIG. 4a (and to some extend FIG. 1). On the outlet from the catalyst portion 6 a second NOx sensor 10 measures the NOₓ content in a reduced gas 14. The electronic controller 3 receives information on the NOₓ content in the reduced gas 14 from the second NOₓ sensor 10. The electronic controller 3 furthermore receives information on the temperature of the gas 2 from a first temperature sensor 17 and the temperature of the reduced gas 14 from a second temperature sensor 18. From the sensory input from the sensors 9, 10, 17, 18 the control unit 3 either selects the optimal reducing agent volume from a predetermined set of values or the control unit 3 calculates an optimal reducing agent volume.

As indicated in FIG. 1, the system for selective catalyst reduction, comprising an inlet of a gas to be catalytically reduced. Such an inlet may preferably be constituted by the piping of the system connected to the exhaust outlet, e.g. the exhaust manifold, of the engine. The system further comprises a control portion to administer an amount of reducing agent to be mixed with the gas to be catalytically reduced. The control portion is typically a computer controlling the doser (4), the valves (7), sootblowing etc. and receives input from the various sensors e.g. pressure sensor (21), NOx sensor, temperature sensor etc. In FIG. 1, the controlling portion is shown by numeral (3).

As further indicated inter alia in FIGS. 1 and 4a and herein, the system comprising a doser portion, that measures out the amount of reducing agent administered by the control portion. With reference to FIGS. 1 and 4, the doser portion is typically a pump (4).

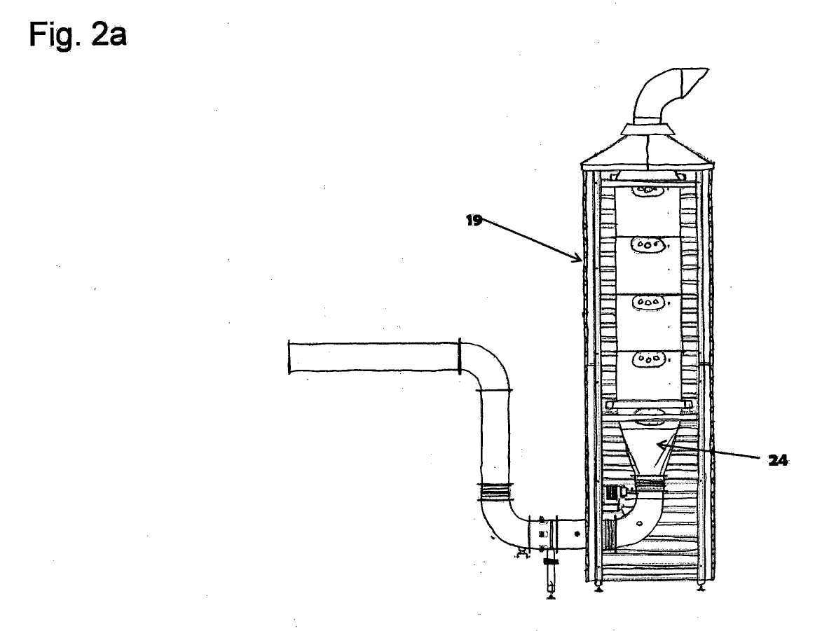

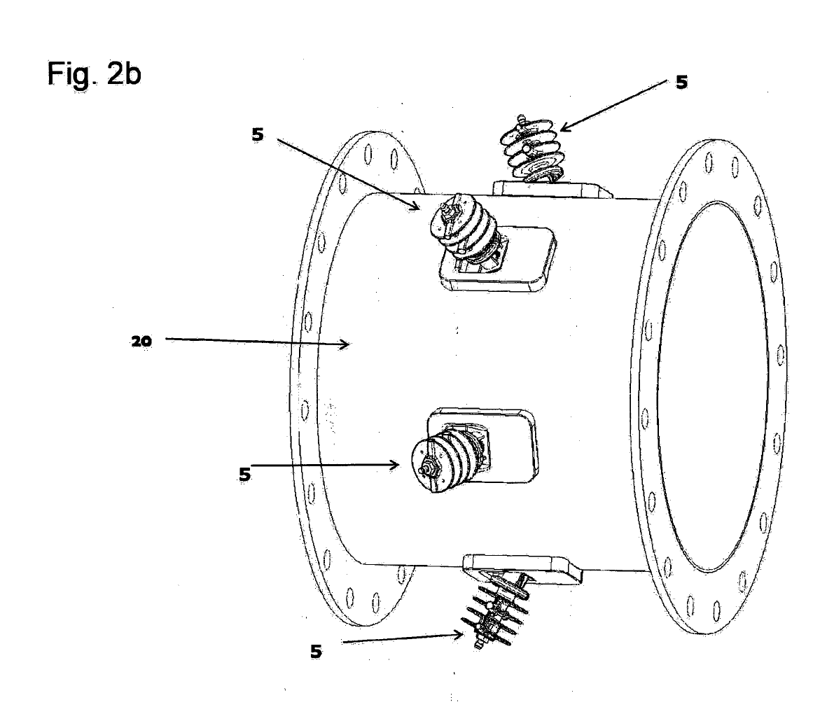

The system further comprising an injection portion that injects the reducing agent into the gas to be catalytically reduced. The injection portion is typically a pipe section with a number of nozzles arranged as indicated in FIG. 2b numeral 20. upstream of,

The injection portion is typically arranged upstream of the catalyst portion (6) that reduces the gas to be catalytically reduced to a reduced gas. Finally, the system comprising an outlet of the reduced gas. The outlet is typically a pipe section terminating the system and may be provided with a hood (23) preventing e.g. rain from entering into the system.

The system may be operated in different way. While the above description lends it self to injection of reducing agent based on a direct signal from the sensor a mapped dosing (urea dosing map) control may be used.

Such mapped dosing control is based on performing a number of test on the engine at various loads and various amounts of reducing agent injected. A NOx sensor is used to detect the amount of reducing agent to be injected at each load scenario to provide a desired NOx conversion and no exhaust of ammonia. All these results are called a map and during non-testing use of the engine, the map is used to provide the amounts of reducing agent to be injected.

The mapping dosing control may be made adaptive in the sense that tests are performed, typically automatically and at regular time interval, to draw a new map. Once the new map is established it is used until a next adaptation of the system is carried out.

An advantage of certain preferred embodiment is that no accumulation of reducing agent may obtained by the reducing agent doser (4). In many injection processes, the amount of fluid being delivered by a nozzle is based on the pressure of the fluid being fed to nozzle and a shut-off valve controlling the flow to the nozzle and regulated to be open for a certain amount of time. When such systems is exposed to wear, e.g. in the nozzle, the amount of fluid delivered by the nozzle will change and often this result in that errors in the amount of fluid delivered are accumulated over time. In the present invention, the reducing agent doser (4) contrary to many other dosing systems measures up the volume of reducing agent 15 requested by the controller 3 from a tank 8 and pumps it through a set of valves 7 to the injection nozzles 5. Thus, this system is not prone to accumulating errors due to wear in nozzles and valves and a very precise and long terme stable delivery of reducing agent due the use of a digitally controlled positive displacement pump may be obtained.

FIG. 2a is a cross-sectional view of another embodiment of the invention. In this embodiment the catalyst portion 6 has been enclosed in a soundproofing portion 19 to reduce noise to the surroundings.

In an embodiment according to the invention the selective catalyst reduction system 1 is placed inside the soundproofing portion 19 to reduce exhaust noise to the surroundings from the engine connected to the selective catalyst reduction system 1.

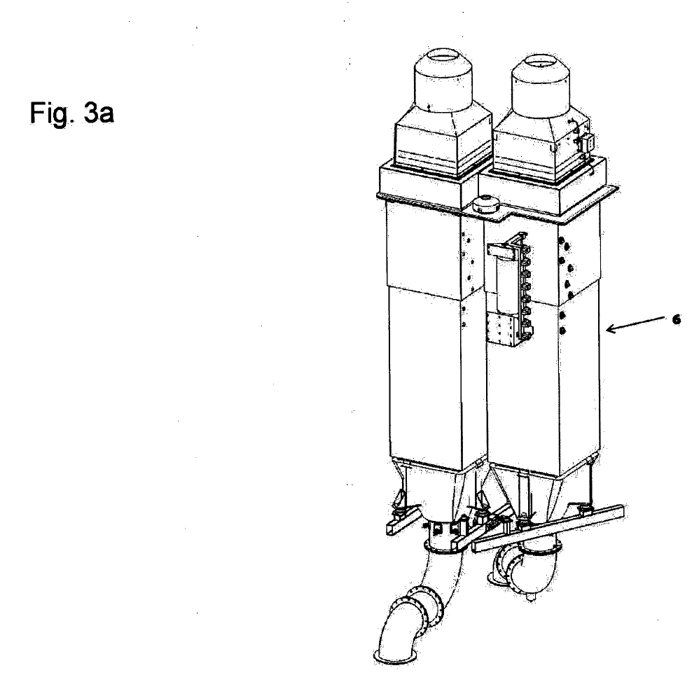

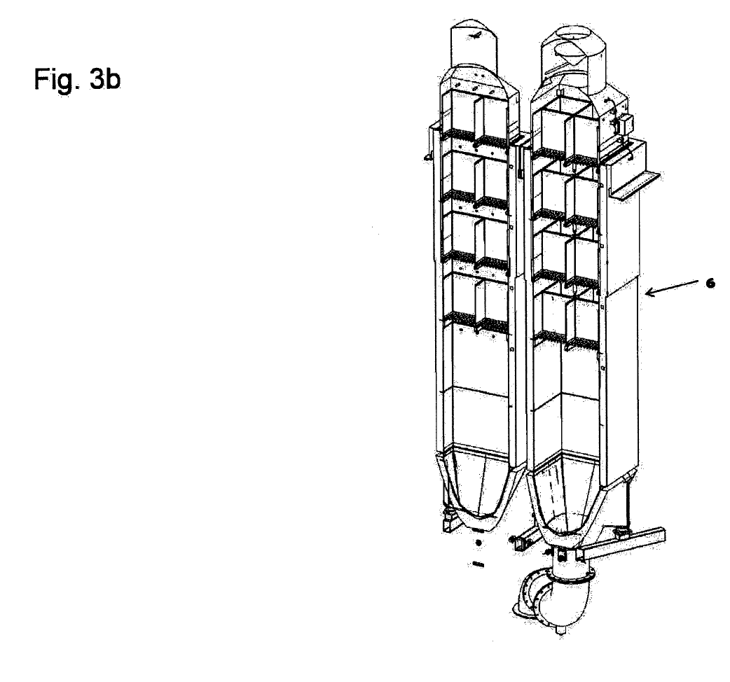

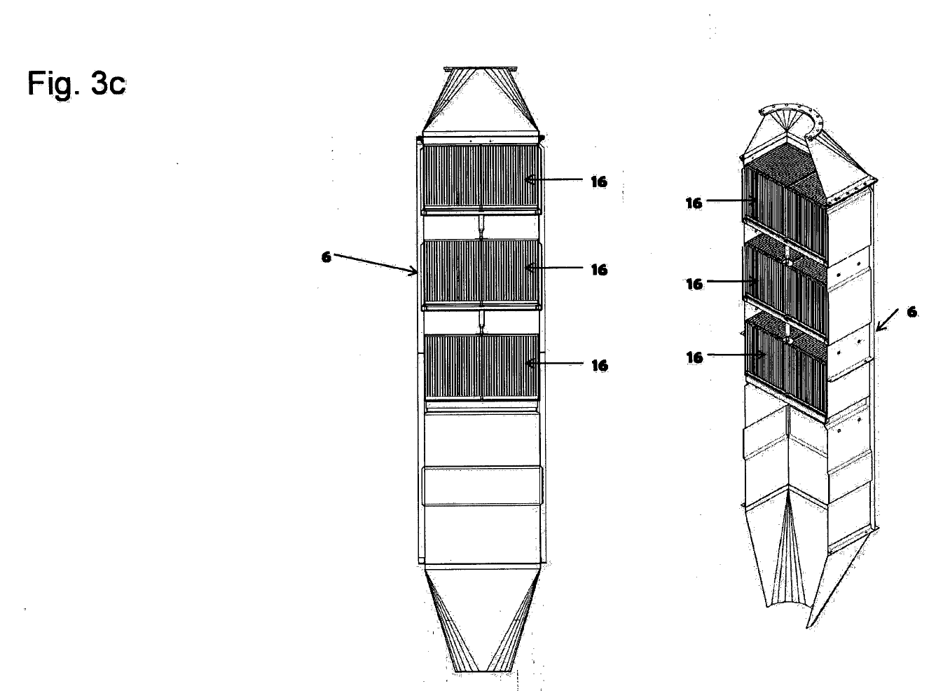

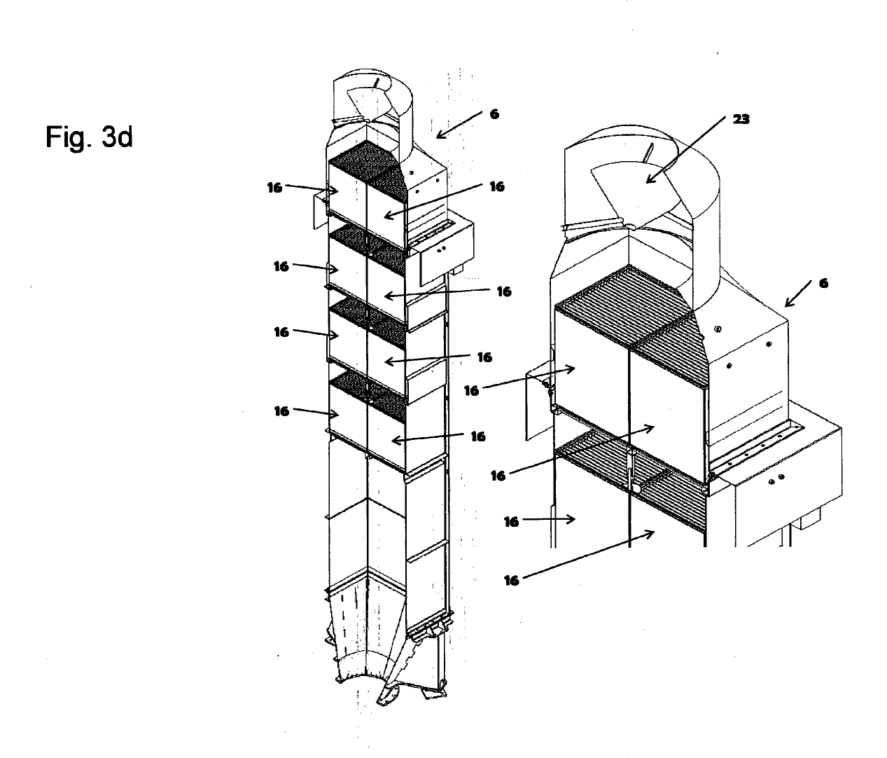

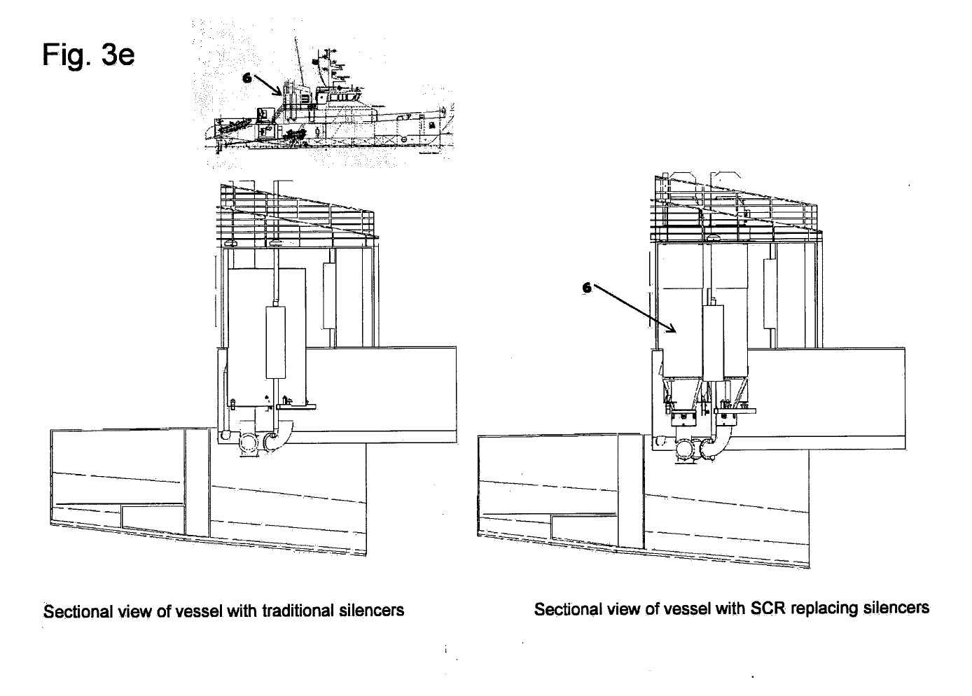

FIG. 3c shows a detailed sectional view of the catalyst portion 6. FIG. 3b also show a detailed sectional view of a catalyst portion 6 but with the catalyst elements 16 removed for clarity. In an embodiment (see e.g. FIG. 3c) according to the invention the catalyst portion 6 becomes the soundproofing portion. The gas is first expanded through the funnel shaped pipe (see e.g. 24 in FIG. 2a) leading gas to the catalyst portion 6. When the gas enters the catalyst portion 6 within the catalyst elements 16 it is compressed, and when the gas enters the volume where the soot blowing system is installed, it is expanded. Thus, the catalyst elements 16 are arranged in series with a void in between each element 16. When the gas flows through the catalyst portion 6 being compressed and expanded several times, the catalyst portion 6 portions acts like what is known as an “Expansion chamber muffler”.

Expansion chamber mufflers reflect waves by introducing a sudden change in cross sectional area in a pipe. They do not have the high attenuation of the Hemholtz resonator, but have a broadband frequency characteristic, with pass bands when half the acoustic wavelength equals the cavity length. Their performance also deteriorates at higher frequencies when the cross axis dimension of the muffler is 82% of the acoustic wavelength.

The soundproofing can be further optimized by placing sound absorbing material in appropriate cavities or on the exterior of the soundproofing portion 19, which helps to improve high frequency attenuation.

FIG. 2b is a 3D view of an embodiment of a tube portion 20 with a plurality of injection nozzles 5 according to the invention. In this embodiment the injection nozzles are situated equidistantly along the perimeter of the tube portion 20. This embodiment is one of several possibilities suited for handling a skewed velocity profiles internally in the exhaust system. As it appears from FIG. 2a, the pippings upstream of the catalyst elements 16 comprising a number 45 degrees turns which will provide a flow internally in the pipe being skewed; for instance a 45 degrees turn will provide a flow where the velocities are highest towards the largest diameter of the turn. This, will produce a mass flow distribution that is skewed requiring more reducing agent where the higher flow velocity are and less reducing agent where the lower velocities are (boundary effects are neglected in this rationale). This skewness may be matched by measuring out different amounts of reducing agents to the various nozzles arranged along the perimeter of the tube portion.

FIG. 3a is a 3D view of an embodiment of two parallel catalyst portions 6 according to the invention. When the selective reduction catalyst system 1 has to reduce NOₓ levels from more than one internal combustion engine 12, a catalyst portion 6 can be coupled to each engine. The electronic controller 3 can control the NOx reduction in a number of parallel catalyst portions by placing injection nozzles (not shown) on each of the exhaust gas inlets of the parallel catalyst portions. In this embodiment the reducing agent tank 8 can supply several reducing agent dosers according to the number of engines in the embodiment. Alternatively the reducing agent doser portion comprises several outputs according to the number of engines in the embodiment.

In another embodiment of the invention, the exhaust gasses from several engines are gathered for NOx removal in one joint selective catalyst reduction system according to the invention.

FIG. 3b is a sectional view of the embodiment of the invention shown in FIG. 3a. The soot blowing system 11 is seen inside the catalyst portion.

FIG. 3d is a detailed sectional view of top of the embodiment of the invention shown in FIG. 3b. The catalyst portions 16 of the invention have to be protected against (sea) water. In installations in vessels this is a special requirement, combined with the limited space available when using the space originally used by the muffler. FIG. 3d shows a detailed solution to this problem.

FIG. 3e is a sectional view of the embodiment of the invention shown in FIG. 3a installed in a vessel (having two engines) in the same space that was originally used for the standard mufflers.

FIG. 4a is a control diagram of an embodiment according to the invention. The control unit 3 receives input from the two NOx sensors 9, 10 and the two temperature sensors 17, 18. Depending on the received input, the control unit 3 sends a control signal to the reducing agent doser 4 preferably a digitally controlled positive displacement pump and a corresponding volume of reducing agent 15 is transferred towards the set of valves 7 leading into the injection nozzles 5. Between the doser 4 and the valves 7 it might in some embodiments be necessary to measure the pressure by a pressure sensor 21. The reason could be that a certain threshold pressure is needed in the nozzles to atomize the reducing agent 15. If the pressure is below this threshold, information may be fed back to the control unit, which could be relevant when the reducing agent volume is very small. In case of very large doses it might be necessary to place a pulse damping unit 22 in the system between the doser 4 and the nozzles 5. In the control diagram information flows from the control unit 3 to each of the valves 7 in order to be able to control each valve 7 and thereby each nozzle 5 separately.

In an embodiment of the invention, the control of the plurality of injection nozzles minmizes the use of each nozzle thereby minimizing the wear on each nozzle. At a given level of content to be reduced e.g. a given engine load level, in a system containing 4 nozzles maybe only 2 nozzles are needed. The control could let the active nozzles switch between using number #1 and #3 to using number #2 and #4 even though the engine load is not changing in order to minimize the wear on each nozzle.

In another embodiments of the invention, the control of the plurality of injection nozzles is done in a way that maximizes the mixing between reducing agent and the gas to be catalytically reduced. By the control of the injection of several nozzles, a better mixing between reducing agent and gas can be provided; this increases the efficiency of the SCR system without the need for a static mixer and/or air treatment unit with both gives an extra counter pressure thereby also a fuel economy penalty. At a given level of content to be reduced e.g. a given engine load level, in a system containing four nozzles maybe only two nozzles are needed. The control could let the active nozzles switch between using number #1 and #3 to using number #2 and #4 and back again to obtain an optimum mixing and distribution of the reducing agent.

FIG. 4b shows another control diagram of an embodiment according to the invention. The amount of reducing agent to be injected into the gas to be catalytically reduced is derived from a “urea dosing map” e.g. the load of the engine combined with a dosing amount table stored in the control portion. This means that the sensory device that determines the level of content to be reduced can be omitted.

The “urea dosing map” can be obtained manually by changing the amount of reducing agent and checking the engine emission to find the optimum amount for a given engine load. But it can also be obtained automatically using a temporary or permanently installed sensory device in the system. This is shown in FIG. 4c.

In a preferred embodiment of the invention, the information from a sensory device that determines the level of content to be reduced before it exits the system is fed back to the control portion. This information combined with the engine load is then used to obtain a “urea dosing map”.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A system for selective catalyst reduction, comprising:
a. an inlet of a gas to be catalytically reduced,
b. a control portion to administer an amount of reducing agent to be mixed with the gas to be catalytically reduced,
c. a doser portion that measures out the amount of reducing agent administered by the control portion,
d. an injection portion that injects the reducing agent into the gas to be catalytically reduced upstream of,
e. a catalyst portion that reduces the gas to be catalytically reduced to a reduced gas, and
f. an outlet of the reduced gas, wherein the injection portion comprises a plurality of injection nozzles and the injection nozzles are adapted to atomize the reducing agent without the need for compressed air to facilitate the atomization.

2-18. (canceled)

19. The system for selective catalyst reduction according to claim 1, wherein injection of reducing agent by each of the plurality of injection nozzles is controlled individually by the control portion.

20. The system for selective catalyst reduction according to claim 19, wherein the control of the injection by the plurality of injection nozzles equalizes the use of each nozzle.

21. The system for selective catalyst reduction according to claim 19, wherein the control of the injection by the plurality of injection nozzles maximizes the mixing between reducing agent and the gas to be catalytically reduced.

22. The system according to claim 1, wherein the doser portion is a digitally controlled positive displacement pump adapted to meter and dose the reducing agent without any accumulating faults.

23. The system for selective catalyst reduction according to claim 1, wherein the catalyst portion is adapted to soundproof the exhaust from the engine connected to the selective catalyst portion.

24. The system according to claim 23, wherein the soundproofing is provided by catalyst elements that are arranged in a series with void volumes in between them.

25. The system according to claim 1, wherein the system does not comprise a separate muffler as a soundproofing element.

26. The system for selective catalyst reduction according to claim 1, wherein the catalyst portion comprises blowing portions to remove soot buildup.

27. The system for selective catalyst reduction according to claim 1, wherein a sensory device determines the level of content to be reduced in the gas to be catalytically reduced.

28. The system for selective catalyst reduction according to claim 27, wherein the control portion uses the information from the sensory device to administer the amount of reducing agent to be injected into the gas to be catalytically reduced.

29. The system for selective catalyst reduction according to claim 1, wherein a sensory device determines the level of content to be reduced before it exits the system for selective catalyst reduction.

30. The system for selective catalyst reduction according to claim 29, wherein the information from the sensory device that determines the level of content to be reduced before it exits the system is fed back to the control portion.

31. The system for selective catalyst reduction according to claim 1, wherein the control portion comprising a urea dosing map storing corresponding values of reducing agent to be injected and engine load and wherein the control portion is adapted to control the injection of reducing agent by the plurality of nozzles based on the urea dosing map.

32. A method for selective catalyst reduction of a gas to be catalytically reduced comprising:
providing a system for selective catalyst reduction that comprises:
(a) an inlet of a gas to be catalytically reduced,
(b) a control portion to administer an amount of reducing agent to be mixed with the gas to be catalytically reduced,
(c) a doser portion that measures out the amount of reducing agent administered by the control portion,
(d) an injection portion that injects the reducing agent into the gas to be catalytically reduced upstream of,
(e) a catalyst portion that reduces the gas to be catalytically reduced to a reduced gas, and
(f) an outlet of the reduced gas, wherein the injection portion comprises a plurality of injection nozzles and the injection nozzles are adapted to atomize the reducing agent without the need for compressed air to facilitate the atomization;
administering an amount of a reducing agent to be mixed with the gas to be catalytically reduced;
measuring out the amount of reducing agent to be mixed with the gas to be catalytically reduced; and
injecting the reducing agent into the gas to be catalytically reduced upstream of a catalyst portion that reduces the gas to be catalytically reduced to a reduced gas.

33. The method according to claim 32, wherein the injection of the reducing agent is done by a plurality of nozzles into exhaust gasses, wherein the injection is controlled by a control portion comprising a urea dosing map storing corresponding values of reducing agent to be injected and engine load.
